(19) United States
(12) Patent Application Publication
(10) Pub. No.: US 2012/0154600 A1
(43) Pub. Date: Jun. 21, 2012

(54) IMAGE PICKUP DEVICE

(75) Inventor: Akihiko Sakamoto, Sagamihara-shi (JP)

(73) Assignee: OLYMPUS CORPORATION, Tokyo (JP)

(21) Appl. No.: 13/324,494

(22) Filed: Dec. 13, 2011

(30) Foreign Application Priority Data
Dec. 16, 2010 (JP) 2010-280268

(51) Int. Cl. H04N 5/225; G06K 9/00

(52) U.S. Cl. 348/169; 382/103; 348/E05.024

(57) ABSTRACT

An image pickup device may include an image pickup unit that captures a subject, an acquiring unit that acquires an absolute position of the image pickup device, an estimating unit that estimates an image capturing direction of the image pickup device, a receiving unit that receives first information or second information from an external terminal, the first information representing an absolute position of the subject, the second information representing an absolute position of the external terminal, an image capturing direction of the external terminal, and a distance from the external terminal to the subject, and a control unit that controls the image capturing direction or notifies an operator of the image pickup device of information instructing that the image capturing direction be changed, based on the absolute position, the image capturing direction, and at least one of the first information and the second information.

### BACKGROUND OF THE INVENTION

1. Field of the Invention

The present invention relates to an image pickup device capable of capturing a subject within an image capturing range.

Priority is claimed on Japanese Patent Application No. 2010-280268, filed Dec. 16, 2010, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

Japanese Unexamined Patent Application, First Publication No. 2002-314851 discloses a technique that makes it easy to continuously capture a desired subject within an image capturing range. In a system disclosed in Japanese Unexamined Patent Application, First Publication No. 2002-314851, a distance between an image capturing device and a subject is calculated based on position information and posture information of the image capturing device acquired using a global positioning system (GPS) circuit and a posture detecting circuit installed in the image capturing device, and subject position information wirelessly received from a subject position detecting unit mounted in the subject. The position or direction of the subject is displayed in or near a real-time image according to the position of the subject on an image capturing screen of the image capturing device. In this specification, the “real-time image” refers to an image that is captured by an image pickup unit and sequentially displayed on a display unit.

### SUMMARY

The present invention provides an image pickup device capable of performing control based on a position of a subject without requiring the subject to measure the position of the subject and transmit position information. In addition, the present invention provides an image pickup device capable of providing information necessary for control based on the position of the subject.

An image pickup device may include: an image pickup unit that captures a subject; an acquiring unit that acquires an absolute position of the image pickup device; an estimating unit that estimates an image capturing direction of the image pickup device; a receiving unit that receives at least one of first information and second information from an external terminal, the first information representing an absolute position of the subject, the second information representing an absolute position of the external terminal, an image capturing direction of the external terminal, and a distance from the external terminal to the subject; and a control unit that controls the image capturing direction of the image pickup device or notifies an operator of the image pickup device of information instructing that the image capturing direction be changed, based on the absolute position acquired by the acquiring unit, the image capturing direction estimated by the estimating unit, and at least one of the first information and the second information.

The image pickup device may further include: a recognizing unit that recognizes the subject based on an image of the subject captured by the image pickup unit; and a transmitting unit that transmits information related to the subject recognized by the recognizing unit to the external terminal.

The transmitting unit may transmit an image of the subject recognized by the recognizing unit to the external terminal.

An image pickup device may include: an image pickup unit that captures a subject; an acquiring unit that acquires an absolute position of the image pickup device; an estimating unit that estimates an image capturing direction of the image pickup device; a calculating unit that calculates a distance from the image pickup device to the subject; and a transmitting unit that transmits at least one of first information and second information to the external terminal, the first information representing an absolute position of the subject calculated based on the absolute position, the image capturing direction, and the distance to an external terminal, the second information representing the absolute position, the image capturing direction, and the distance.

The image pickup device may further include a receiving unit that receives an acquisition request of position information of the subject from the external terminal. The transmitting unit may transmit at least one of the first information and the second information to the external terminal after the acquisition request is received.

The image pickup device may further include a receiving unit that receives information related to the subject from the external terminal. The calculating unit may calculate a distance from the subject related to the information received by the receiving unit.

The transmitting unit may repetitively transmit at least one of the first information and the second information.

According to the preferred embodiment of the present invention, based on first information representing an absolute position and an image capturing direction of the image pickup device and an absolute position of a subject received from an external terminal or second information representing an absolute position and an image capturing direction of the external terminal and a distance from the external terminal to the subject, the image capturing direction of the image pickup device is controlled, or control is performed such that an operator of the image pickup device is presented with information instructing that the image capturing direction of the image pickup device be changed. Thus, control can be performed based on the position of the subject without requiring the subject to measure its position and transmit the position information.

According to the preferred embodiment of the present invention, by transmitting the first information or the second information to the external terminal, it is possible to provide information necessary for control based on the position of the subject.

### BRIEF DESCRIPTION OF THE DRAWINGS

The above features and advantages of the present invention will be more apparent from the following description of certain preferred embodiments taken in conjunction with the accompanying drawings, in which:

FIGS. 1A and 1B are configuration diagrams illustrating a configuration of a subject position notification system in accordance with a first preferred embodiment of the present invention;

FIG. 2 is a block diagram illustrating a configuration of the position information providing terminal in accordance with the first preferred embodiment of the present invention;

FIG. 3 is a block diagram illustrating a configuration of the position information display terminal in accordance with the first preferred embodiment of the present invention;

FIG. 4 is a flowchart illustrating a procedure of an operation of the position information providing terminal in accordance with the first preferred embodiment of the present invention;

FIG. 5 is a reference diagram illustrating, a method of calculating the position information of the subject in accordance with the first preferred embodiment of the present invention;

FIG. 6 is a flowchart illustrating a procedure of an operation of the position information display terminal in accordance with the first preferred embodiment of the present invention;

FIGS. 7A to 7D are reference diagrams illustrating a method of calculating the subject position display information in accordance with the first preferred embodiment of the present invention;

FIGS. 8A to 8D are configuration diagrams illustrating a configuration of a subject position notification system in accordance with a second preferred embodiment of the present invention;

FIG. 9 is a block diagram illustrating a configuration of the position information display terminal in accordance with the second preferred embodiment of the present invention;

FIG. 10 is a block diagram illustrating a configuration of the position information providing terminal in accordance with the second preferred embodiment of the present invention;

FIG. 11 is a flowchart illustrating a procedure of an operation of the position information display terminal in accordance with the second preferred embodiment of the present invention;

FIG. 12 is a flowchart illustrating a procedure of an operation of the position information providing terminal in accordance with the second preferred embodiment of the present invention;

FIG. 13 is a block diagram illustrating a configuration of a modification of the position information providing terminal and the position information display terminal in accordance with the first preferred embodiment of the present invention;

FIG. 14 is a flowchart illustrating a procedure of an operation of a modification of the position information providing terminal in accordance with the first preferred embodiment of the present invention;

FIG. 15 is a flowchart illustrating a procedure of an operation of a modification of the position information display terminal in accordance with the first preferred embodiment of the present invention;

FIG. 16 is a block diagram illustrating a configuration of a modification of the position information providing terminal and the position information display terminal in accordance with the second preferred embodiment of the present invention;

FIG. 17 is a flowchart illustrating a procedure of an operation of a modification of the position information providing terminal in accordance with the second preferred embodiment of the present invention;

FIG. 18 is a flowchart illustrating a procedure of an operation of a modification of the position information display terminal in accordance with the second preferred embodiment of the present invention;

FIG. 19 is a configuration diagram illustrating a configuration of a modification of the subject position notification system in accordance with the first and second preferred embodiments of the present invention;

FIG. 20 is a configuration diagram illustrating a configuration of a modification of the subject position notification system in accordance with the first and second preferred embodiments of the present invention;

FIG. 21 is a block diagram illustrating a configuration of a modification of the position information display terminal in accordance with the first preferred embodiment of the present invention; and

FIG. 22 is a block diagram illustrating a configuration of a modification of the position information display terminal in accordance with the second preferred embodiment of the present invention.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

### First Preferred Embodiment

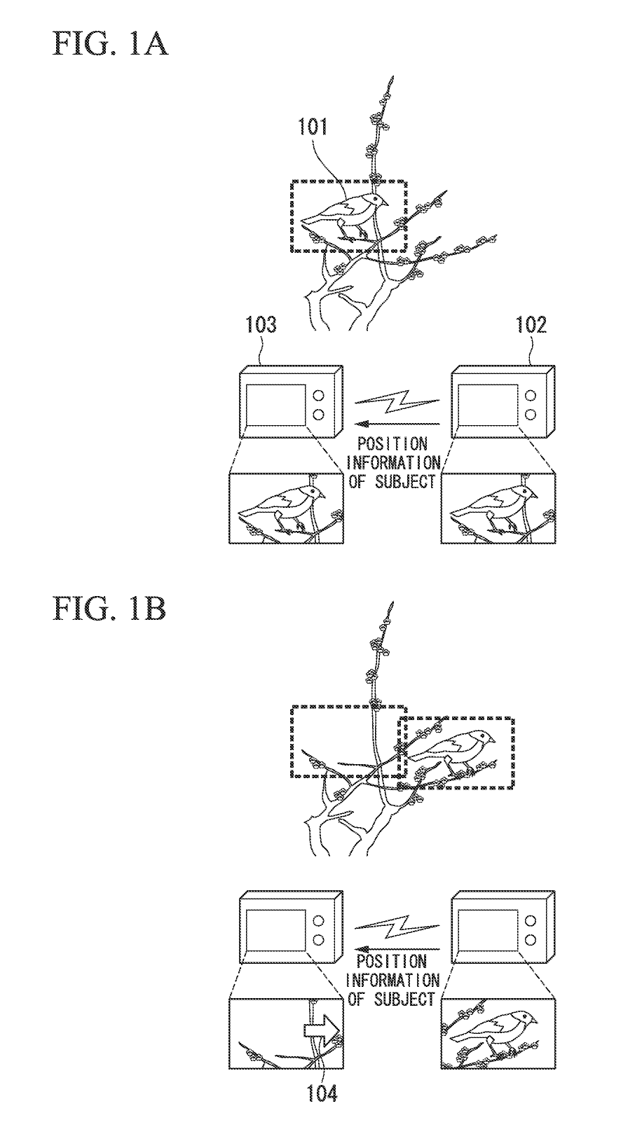

A first preferred embodiment of the present invention will be described. FIGS. 1A and 1B are configuration diagrams illustrating an example of a configuration of a subject position notification system that notifies an operator of a position or direction of a desired subject when the desired subject is not present within an image capturing range. In this subject position notification system, when a subject 101 is not present within an image capturing range of a position information display terminal 103 that is an image pickup device for continuously receiving position information of the subject from a position information providing terminal 102 that is an image pickup device for capturing the subject 101 within an image capturing range, information representing a direction of the subject 101 is displayed on a real-time image of the position information display terminal 103 in a superimposed manner.

An example of FIG. 1A shows an aspect of a real-time image when the subject 101 is present within the image capturing range of the position information display terminal 103. An example of FIG. 1B shows an aspect in which a direction of the subject 101 is notified of by displaying an arrow 104 on the real-time image in a superimposed manner when the subject 101 is not present within the image capturing range of the position information display terminal 103.

In FIG. 1B, notification by the arrow 104 has been performed as a method of notifying of the direction of the subject 101, but the notification method is not limited only to the arrow 104. For example, various notification methods such as notification by blinking of a light emitting diode (LED) or a change in color of an LED, notification by voice guidance, or notification by text may be used.

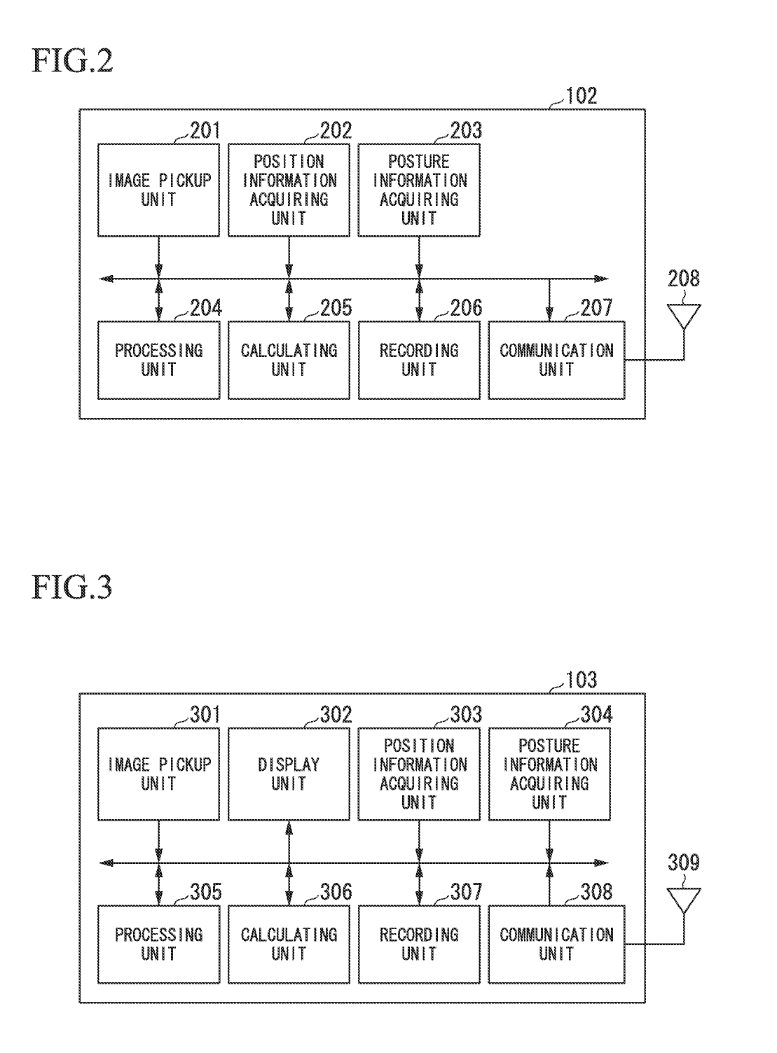

FIG. 2 is a block diagram illustrating a configuration of the position information providing terminal 102 in accordance with the first preferred embodiment of the present invention. The configuration of the position information providing terminal 102 will be described below with reference to FIG. 2. The position information providing terminal 102 in accordance with the first preferred embodiment of the present invention includes an image pickup unit 201, a position information acquiring unit 202, a posture information acquiring unit 203, a processing unit 204, a calculating unit 205, a recording unit 206, a communication unit 207, and an antenna 208. The image pickup unit 201 corresponds to an image pickup unit in the present invention. The position information acquiring unit 202 corresponds to an acquiring unit in the present invention. The posture information acquiring unit 203 corresponds to an estimating unit in the present invention. The calculating unit 205 corresponds to a calculating unit in the present invention. The communication unit 207 and the antenna 208 correspond to a transmitting unit and a receiving unit in the present invention, respectively.

The image pickup unit 201 generates a real-time image by capturing the subject and measures the distance between the position information providing terminal 102 and the subject. The position information acquiring unit 202 acquires position information representing an absolute position of the position information providing terminal 102. For example, the position information acquiring unit 202 may be configured with a GPS sensor. The other position information acquiring units described in this specification may be similarly configured with a GPS sensor or the like. The posture information acquiring unit 203 acquires posture information of the position information providing terminal 102. For example, the posture information acquiring unit 203 may be configured with a geomagnetic sensor and an acceleration sensor. The other posture information acquiring units described in this specification may be similarly configured with a geomagnetic sensor, an acceleration sensor, and the like. An image capturing direction in which the position information providing terminal 102 is capturing the subject, that is, a direction of the subject viewed from the position information providing terminal 102, can be estimated based on the posture information.

The processing unit 204 controls an operation of the position information providing terminal 102. The calculating unit 205 calculates the position information representing the absolute position of the subject based on the position information and the posture information of the position information providing terminal 102 and the distance to the subject. The recording unit 206 includes a recording medium for recording the position information and the posture information of the position information providing terminal 102, the distance between the position information providing terminal 102 and the subject, the position information of the subject, and the like. The communication unit 207 and the antenna 208 perform wireless communication with the position information display terminal 103.

FIG. 3 is a block diagram illustrating a configuration of the position information display terminal 103 in accordance with the first preferred embodiment of the present invention. A configuration of the position information display terminal 103 will be described below with reference to FIG. 3. The position information display terminal 103 in accordance with the first preferred embodiment of the present invention includes an image pickup unit 301, a display unit 302, a position information acquiring unit 303, a posture information acquiring unit 304, a processing unit 305, a calculating unit 306, a recording unit 307, a communication unit 308, and an antenna 309. The image pickup unit 301 corresponds to an image pickup unit in the present invention. The position information acquiring unit 303 corresponds to an acquiring unit in the present invention. The posture information acquiring unit 304 corresponds to an estimating unit in the present invention. The communication unit 308 and the antenna 309 correspond to a transmitting unit and a receiving unit in the present invention, respectively. The processing unit 305 corresponds to a control unit in the present invention.

The image pickup unit 301 generates a real-time image by capturing the subject and acquires field angle information. The display unit 302 displays the real-time image and displays the direction of the subject so as to instruct the operator to change the image capturing direction. The position information acquiring unit 303 acquires position information representing an absolute position of the position information display terminal 103. The posture information acquiring unit 304 acquires posture information of the position information display terminal 103. The image capturing direction in which the position information display terminal 103 is capturing the subject can be estimated based on the posture information.

The processing unit 305 controls an operation of the position information display terminal 103. The calculating unit 306 calculates the direction of the subject based on the position information, the posture information, and the field angle information of the position information display terminal 103 and the position information of the subject received from the position information providing terminal 102. The recording unit 307 includes a recording medium for recording the position information and the posture information of the position information display terminal 103 and the position information of the subject received from the position information providing terminal 102. The communication unit 308 and the antenna 309 perform wireless communication with the position information providing terminal 102.

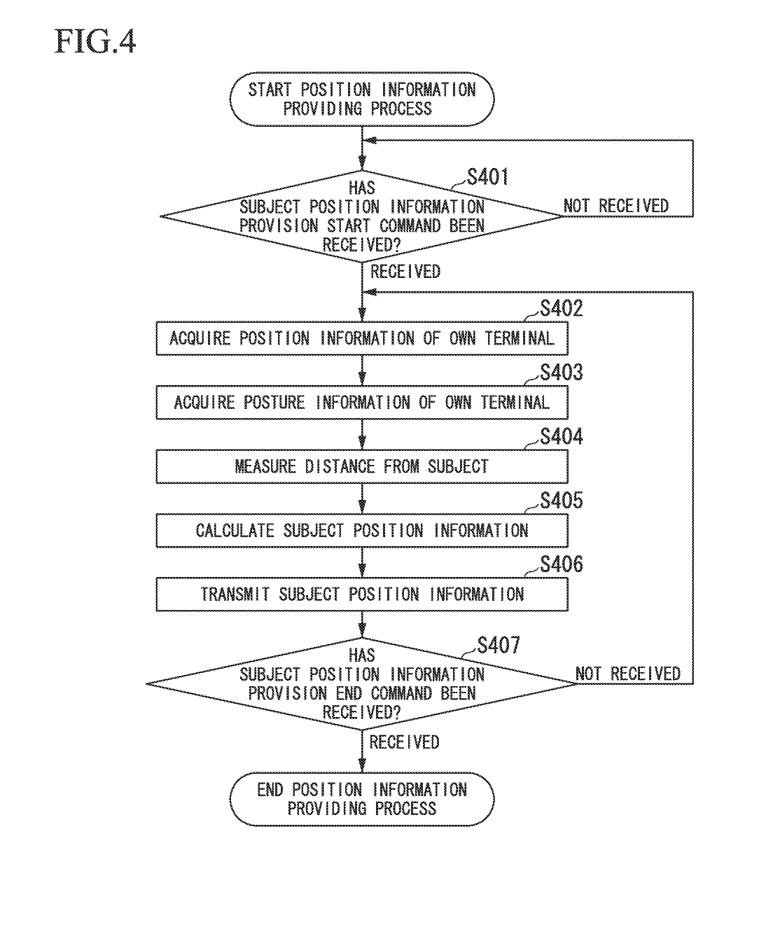

Next, an operation of the position information providing terminal 102 in accordance with the first preferred embodiment of the present invention will be described with reference to FIG. 4. FIG. 4 is a flowchart illustrating a procedure of an operation of the position information providing terminal in accordance with the first preferred embodiment of the present invention. When a subject position information provision start command is received from the position information display terminal 103 via the communication unit 207 and the antenna 208, the processing unit 204 starts a position information providing process (step S401). In the first preferred embodiment of the present invention, the subject position information provision start command refers to a command that causes the position information providing terminal 102 to start the position information providing process.

When the subject position information provision start command is received, the processing unit 204 acquires the position information of the position information providing terminal 102 from the position information acquiring unit 202 and records the acquired position information in the recording unit 206 (step S402). In the first preferred embodiment of the present invention, information including at least the latitude, the longitude, and the altitude of the position information providing terminal 102 is used as the position information of the position information providing terminal 102.

After the position information of the position information providing terminal 102 is recorded, the processing unit 204 acquires the posture information of the position information providing terminal 102 from the posture information acquiring unit 203 and records the acquired posture information in the recording unit 206 (step S403). In the first preferred embodiment of the present invention, information including at least an azimuth direction in which the position information providing terminal 102 faces and an angle of elevation or depression of the position information providing terminal 102 is used as the posture information of the position information providing terminal 102.

After the posture information of the position information providing terminal 102 is recorded, the processing unit 204 controls the image pickup unit 201 to focus on the subject, measures the distance from the position information providing terminal 102 to the subject based on the distance between the focal length of the image pickup unit 201 and the distance between a lens and an capturing element, and records the measured distance in the recording unit 206 (step S404).

After the distance from the position information providing terminal 102 to the subject is recorded, the processing unit 204 issues a subject position calculation command to the calculating unit 205. In the first preferred embodiment of the present invention, the subject position calculation command refers to a command that causes the calculating unit 205 to start a process of calculating the position information of the subject.

When the subject position calculation command is received, the calculating unit 205 calculates the position information of the subject using the position information of the position information providing terminal 102 acquired in step S402, the posture information of the position information providing terminal 102 acquired in step S403, and the distance from the position information providing terminal 102 to the subject acquired in step S404, and then records the calculated position information of the subject in the recording unit 206 (step S405). In the first preferred embodiment of the present invention, information including at least the latitude, the longitude, and altitude of the subject is used as the position information of the subject. A method of calculating the position information of the subject will be described later.

After the position information of the subject is recorded, the calculating unit 205 issues a subject position calculation completion notice to the processing unit 204. In the first preferred embodiment of the present invention, the subject position calculation completion notice refers to a message for notifying the processing unit 204 of the fact that a calculation of the position information of the subject has been completed.

When the subject position calculation completion notice is received, the processing unit 204 transmits the position information of the subject recorded in the recording unit 206 to the position information display terminal 103 via the communication unit 207 and the antenna 208 (step S406).

After the position information of the subject is transmitted, the processing unit 204 determines whether or not a subject position information provision end command is received from the position information display terminal 103 via the antenna 208 and the communication unit 207 (step S407). When the subject position information provision end command is received, the processing unit 204 ends the position information providing process. However, when the subject position information provision end command is not received, the process returns to step S402, and the position information of the subject is calculated and transmitted again. In the first preferred embodiment of the present invention, the subject position information provision end command refers to a command that causes the position information providing terminal 102 to end the position information providing process.

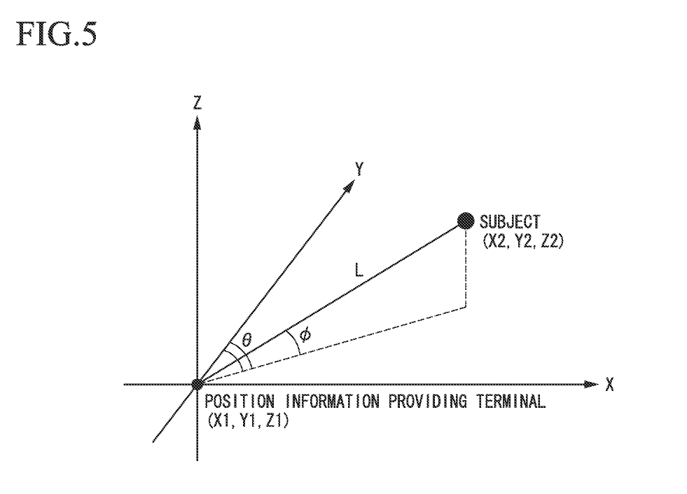

Next, a method of calculating the position information of the subject that is calculated by the calculating unit 205 in step S406 will be described with reference to FIG. 5. FIG. 5 is a reference diagram illustrating a method of calculating the position information of the subject in accordance with the first preferred embodiment of the present invention. In FIG. 5, X, Y, and Z represent the longitude, the latitude, and the altitude, respectively. In FIG. 5, (X1, Y1, Z1) represents the position information of the position information providing terminal 102 that is acquired in step S402. In FIG. 5, θ and φ represent an azimuth direction in which the position information providing terminal 102 faces and an angle of elevation or depression of the position information providing terminal 102, respectively. That is, θ and φ represent the posture information of the position information providing terminal 102 acquired in step S403. Further, in FIG. 5, L represents the distance between the position information providing terminal 102 and the subject that is acquired in step S404. Further, in FIG. 5, (X2, Y2, Z2) represents the position information of the subject that is calculated in step S405.

Based on the parameters indicated in FIG. 5, the position information of the subject is calculated according to calculation formulas expressed in Formula 1 to Formula 3.

X2=X1+L cos φ sin θ (1)

Y2=Y1+L cos φ cos θ (2)

Z2=Z1+L sin φ (3)

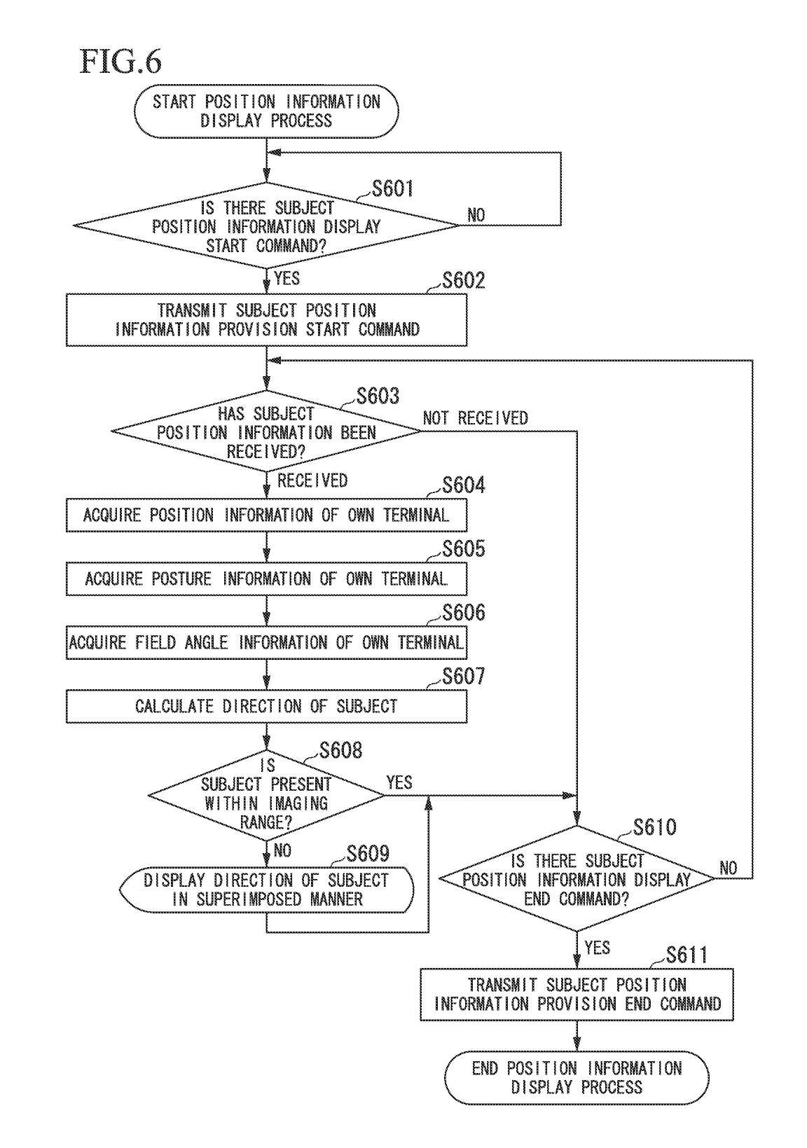

Next, an operation of the position information display terminal 103 in accordance with the first preferred embodiment of the present invention will be described with reference to FIG. 6. FIG. 6 is a flowchart illustrating a procedure of an operation of the position information display terminal in accordance with the first preferred embodiment of the present invention. When a subject position information display start command is received, the processing unit 305 starts a position information display process (step S601). In the first preferred embodiment of the present invention, the subject position information display start command refers to a command that causes the position information display terminal 103 to start the position information display process. In addition, in the first preferred embodiment of the present invention, the subject position information display start command is issued using the fact that the position information providing terminal 102 and the position information display terminal 103 connect to the same network as a trigger. However, the condition under which the subject position information display start command is issued is not limited to this condition. For example, a user interface unit may be further added to the configuration of the position information display terminal 103 illustrated in FIG. 3, and the subject position information display start command may be issued using a user's input as a trigger condition. Various other conditions are also conceivable.

When the subject position information display start command is received, the processing unit 305 transmits the subject position information provision start command to the position information providing terminal 102 via the communication unit 308 and the antenna 309 (step S602).

After the subject position information provision start command is transmitted, the processing unit 305 enters a reception standby state for receiving the position information of the subject transmitted from the position information providing terminal 102 via the communication unit 308 and the antenna 309 (step S603). When the position information of the subject is received, the processing unit 305 records the position information of the subject in the recording unit 307 and then performs processing of step S604. However, when a predetermined time elapses in the reception standby state, the processing unit 305 performs processing of step S610.

After the position information of the subject is recorded, the processing unit 305 acquires the position information of the position information display terminal 103 from the position information acquiring unit 303 and records the acquired position information in the recording unit 307 (step S604). In the first preferred embodiment of the present invention, information including at least the latitude, the longitude, and the altitude of the position information display terminal 103 is used as the position information of the position information display terminal 103.

After the position information of the position information display terminal 103 is recorded, the processing unit 305 acquires the posture information of the position information display terminal 103 from the posture information acquiring unit 304 and records the acquired posture information in the recording unit 307 (step S605). In the first preferred embodiment of the present invention, information including an azimuth direction in which the position information display terminal 103 faces and an angle of elevation or depression of the position information display terminal 103 is used as the posture information of the position information display terminal 103.

After the posture information of the position information display terminal 103 is recorded, the processing unit 305 acquires the field angle information of the position information display terminal 103 from the image pickup unit 301 and records the acquired field angle information in the recording unit 307 (step S606). After the field angle information of the position information display terminal 103 is recorded, the processing unit 305 issues a subject position display information calculation command to the calculating unit 306. In the first preferred embodiment of the present invention, the subject position display information calculation command refers to a command that causes the calculating unit 306 to start a calculation of a direction of the subject (hereinafter referred to as “subject position display information”) with reference to the position and the posture of the position information display terminal 103.

When the subject position display information calculation command is received, the calculating unit 306 calculates the subject position display information using the position information of the subject acquired in step S603, the position information of the position information display terminal 103 acquired in step S604, the posture information of the position information display terminal 103 acquired in step S605, and the field angle information of the position information display terminal 103 acquired in step S606, which are recorded in the recording unit 307, and then records the calculated subject position display information in the recording unit 307 (step S607).

After the subject position display information is recorded, the calculating unit 306 issues a subject position display information calculation completion notice to the processing unit 305. In the first preferred embodiment of the present invention, the subject position display information calculation completion notice is a message notifying the processing unit 305 of the fact that the calculation of the subject position display information has been completed. In addition, in the first preferred embodiment of the present invention, when the subject is present within the image capturing range, the subject position display information is not recorded. A method of calculating the subject position display information will be described later.

When the subject position display information calculation completion notice is received, the processing unit 305 determines whether or not the subject position display information remains recorded in the recording unit 307 (step S608). This determination is the same as the determination as to whether or not the subject is present within the image capturing range. When the subject position display information remains recorded, it is determined that the subject is not present within the image capturing range, and the processing unit 305 performs processing of step S609. However, when the subject position display information remains unrecorded, it is determined that the subject is present within the image capturing range, and the processing unit 305 performs processing of step S610.

When the subject position display information remains recorded in the recording unit 307, the processing unit 305 acquires the subject position display information from the recording unit 307 and controls the display unit 302 such that the subject position display information is displayed on the real-time image in the superimposed manner (step S609). Thus, the operator can be notified of the direction of the subject and instructed to change the image capturing direction.

When it is determined in step S603 that the position information of the subject has not been received, when the subject position display information remains unrecorded in the recording unit 307, or when the subject position display information is completely superimposed on the real-time image, the processing unit 305 determines whether or not a subject position information display end command has been issued (step S610). When the subject position information display end command has not been issued, the processing unit 305 performs processing of step S603. However, when the subject position information display end command has been issued, the processing unit 305 performs processing of step S611.

In the first preferred embodiment of the present invention, the subject position information display end command refers to a command that causes the position information display terminal 103 to end the position information display process. In addition, in the first preferred embodiment of the present invention, the subject position information display end command is issued before departing from a current network using the network departure as a trigger. However, the condition under which the subject position information display end command is issued is not limited to this condition. For example, a user interface unit may be further added to the configuration of the position information display terminal 103 illustrated in FIG. 3, and the subject position information display end command may be issued using a user's input as a trigger condition. Alternatively, when the subject position information has not been received a predetermined number of times in step S603, this fact may be used as a trigger for issuing the command. Various other conditions are also conceivable.

When the subject position information display end command has been issued, the processing unit 305 transmits the subject position information provision end command to the position information providing terminal 102 via the communication unit 308 and the antenna 309, and then ends the position information display process (step S611).

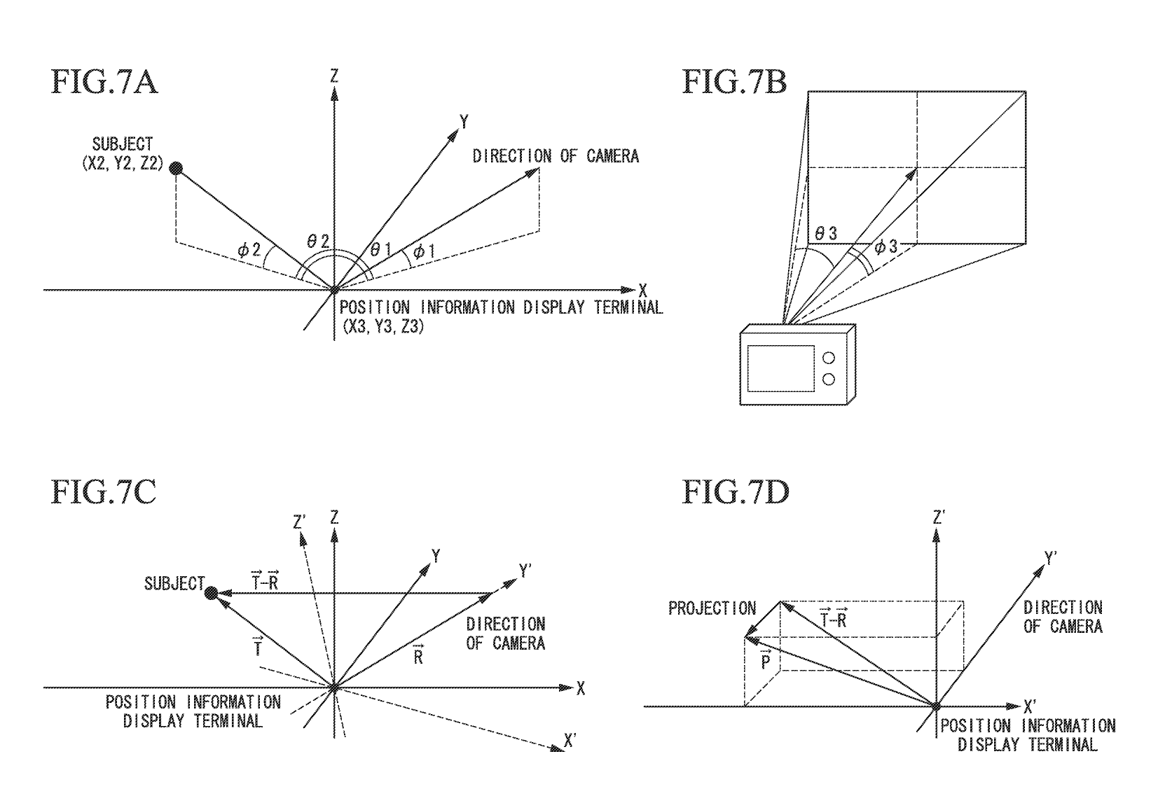

Next, a method of calculating the subject position display information that is calculated by the calculating unit 306 in step S607 will be described with reference to FIGS. 7A to 7D. FIGS. 7A to 7D are reference diagrams illustrating a method of calculating the subject position display information in accordance with the first preferred embodiment of the present invention. In FIGS. 7A to 7D, X, Y, and Z represent the longitude, the latitude, and the altitude, respectively. In FIG. 7A, (X2, Y2, Z2) represents the position information of the subject that is acquired in step S603. In FIG. 7A, (X3, Y3, Z3) represents the position information of the position information display terminal 103 that is acquired in step S604. In addition, in FIG. 7A, θ1 and φ1 represent an azimuth direction in which the position information display terminal 103 faces and an angle of elevation or depression of the position information display terminal 103, respectively. That is, θ1 and φ1 represent the posture information of the position information display terminal 103 acquired in step S605. In FIG. 7A, θ2 and φ2 are calculation targets.

The calculating unit 306 calculates θ2 and φ2 using Formulas 4 and 5:

$$\begin{matrix}θ 2 = {tan}^{- 1} \frac{X 2 - X 3}{Y 2 - Y 3} & ( 4 ) \\ φ 2 = {tan}^{- 1} \frac{Z 2 - Z 3}{\sqrt{{( X 2 - X 3 )}^{2} + {( Y 2 - Y 3 )}^{2}}} & ( 5 )\end{matrix}$$

After θ2 and φ2 are calculated, the calculating unit 306 calculates the azimuth direction of the subject and the angles of elevation or depression of the subject with reference to the position and posture of the position information display terminal 103 using Formulas 6 and 7:

Azimuth direction: θ2−θ1 (6)

Angle of elevation or depression: φ2−φ1 (7)

After the azimuth direction of the subject and the angle of elevation or depression of the subject are calculated with reference to the position and posture of the position information display terminal 103, the calculating unit 306 determines whether or not the subject is present within the image capturing range by checking whether or not conditions represented by Formulas 8 and 9 are satisfied. In the first preferred embodiment of the present invention, the field angle information acquired in step S606 is information in which the azimuth direction and the angle of elevation or depression are represented by θ3 and φ3, respectively, as illustrated in FIG. 7B.

Azimuth direction: θ1−θ3<θ2−θ1<θ1+θ3 (8)

Angle of elevation or depression: φ1−φ3<φ2−φ1<φ1+φ3 (9)

When the conditions represented by Formulas 8 and 9 are not satisfied, the calculating unit 306 calculates a unit vector (hereinafter referred to as “posture vector”) of a vector representing a direction in which the position information display terminal 103 faces and a unit vector (hereinafter referred to as “subject vector”) of a vector representing the position of the subject with reference to the position of the position information display terminal 103. Then, the calculating unit 306 calculates a vector (hereinafter referred to as “display vector”) representing an ending point of the subject vector when an ending point of the posture vector is used as a starting point. The posture vector, the subject vector, and the display vector are represented as follows in FIG. 7, respectively:
Posture vector: R̅
Subject Vector: T̅
Display vector: T̅− R̅

After the display vector is calculated, the calculating unit 306 calculates a vector obtained by projecting the display vector on a plane (which corresponds to an image pickup surface of the image pickup unit 301) orthogonal to the posture vector as illustrated in FIG. 7D and records the calculated vector in the recordinu unit 307. The vector recorded in the recording unit 307 is the subject position display information. In FIG. 7D, the vector of the subject position display information is represented as follows:
Vector of subject position display information: P̅

In the first preferred embodiment of the present invention, the above described method is used as the method of calculating the subject position display information, but the calculation method is not limited to the above described calculation method as long as the subject position display information can be calculated.

The first preferred embodiment of the present invention has been described above. According to the first preferred embodiment of the present invention, even when it is difficult for the subject to acquire and provide the position information, the position information display terminal 103 can acquire the position information of the subject acquired by the position information providing terminal 102 and perform control (display the position or the direction of the subject in the first preferred embodiment of the present invention) based on the position information of the subject.

The position information providing terminal 102 can provide information necessary for performing control based on the position information of the subject by the position information display terminal 103.

In addition, according to the first preferred embodiment of the present invention, the position information display terminal 103 notifies the operator of the image capturing direction based on the position information of the subject received from the position information providing terminal 102 and thus can easily set the subject in the real-time image of the position information display terminal 103.

Further, according to the first preferred embodiment of the present invention, the position information providing terminal 102 repetitively transmits the position information of the subject until the subject position information provision end command is received, and thus the position information of the subject can be continuously provided in real time.

Furthermore, according to the first preferred embodiment of the present invention, the position information providing terminal 102 transmits the position of the subject using reception of the subject position information provision start command transmitted from the position information display terminal 103 as a trigger, and thus the position information of the subject can be transmitted at a desired timing.

### Second Preferred Embodiment

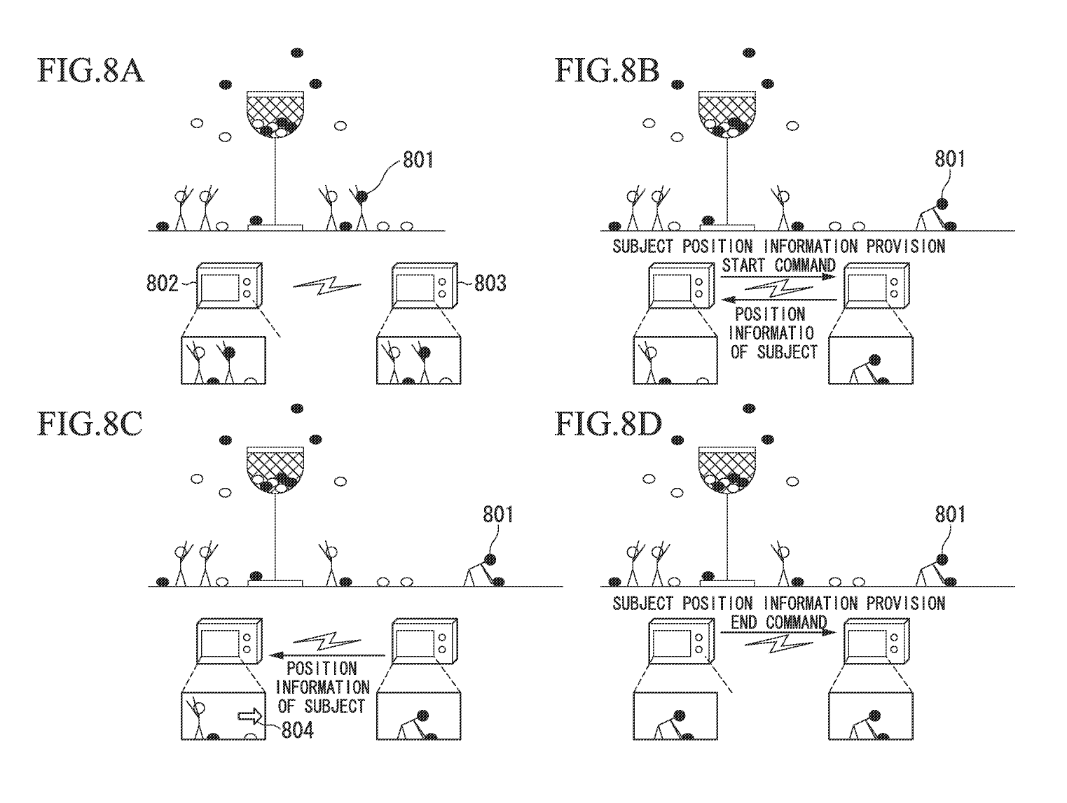

Next, a second preferred embodiment of the present invention will be described. FIGS. 8A to 8D are configuration diagrams illustrating an example of a configuration of a subject position notification system that notifies an operator of the position or a direction of a desired subject only when the desired subject leaves the image capturing range. In this subject position notification system, only when a subject 1 leaves an image capturing range of a position information display terminal 802 that is an image pickup device, the position information display terminal 802 receives the position information of the subject from a position information providing terminal 803 that is an image pickup device, and a direction of the subject 801 is displayed on a real-time image of the position information display terminal 802 in a superimposed manner.

FIG. 8A illustrates an aspect of a real-time image when the subject 801 is present within the image capturing range of the position information display terminal 802. FIG. 8B illustrates an aspect of a real-time image when the subject 801 leaves the image capturing range of the position information display terminal 802 and an aspect of communication between the position information display terminal 802 and the position information providing terminal 803.

FIG. 8C illustrates an aspect in which an arrow 804 representing a direction of the subject is displayed on the real-time image of the position information display terminal 802 in the superimposed manner. FIG. 80 illustrates an aspect of the real-time image when the position information display terminal 802 captures the subject 801 within the image capturing range again and an aspect of communication between the position information display terminal 802 and the position information providing terminal 803.

In FIG. 8C, as a method of notifying of the direction of the subject 801, notification by the arrow 804 is performed, but the notification method is not limited only to the arrow 804. For example, various notification methods such as notification by blinking of an LED or a change in color of an LED, notification by voice guidance, or notification by text may be used.

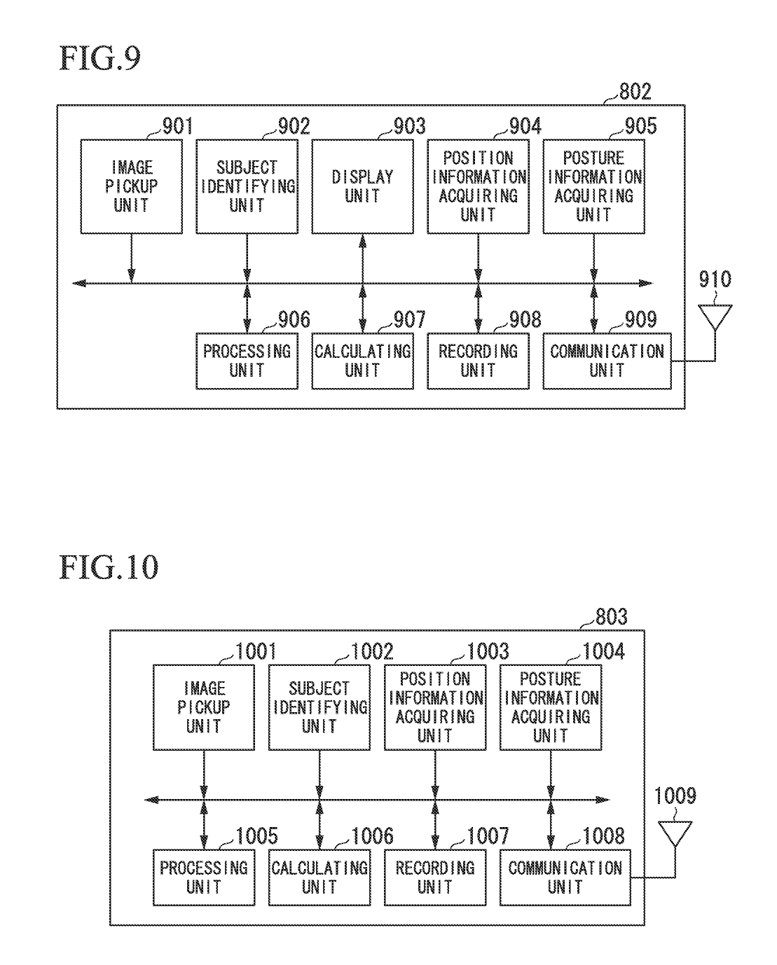

FIG. 9 is a block diagram illustrating a configuration of the position information display terminal 802 in accordance with the second preferred embodiment of the present invention. A configuration of the position information display terminal 802 will be described below with reference to FIG. 9. The position information display terminal 802 in accordance with the second preferred embodiment of the present invention includes an image pickup unit 901, a subject identifying unit 902, a display unit 903, a position information acquiring unit 904, a posture information acquiring unit 905, a processing unit 906, a calculating unit 907, a recording unit 908, a communication unit 909, and an antenna 910. The image pickup unit 901 corresponds to an image pickup unit in the present invention. The position information acquiring unit 904 corresponds to an acquiring unit in the present invention. The posture information acquiring unit 905 corresponds to an estimating unit in the present invention. The communication unit 909 and the antenna 910 correspond to a transmitting unit and a receiving unit in the present invention, respectively. The processing unit 906 corresponds to a control unit in the present invention. The subject identifying unit 902 corresponds to an identifying unit in the present invention.

The image pickup unit 901 generates a real-time image by capturing the subject and acquires field angle information. The subject identifying unit 902 identifies the subject that is being viewed in the real-time image based on subject identification information recorded in the recording unit 908. The display unit 903 displays the real-time image and displays the direction of the subject so as to instruct the operator to change the image capturing direction. The position information acquiring unit 904 acquires position information representing an absolute position of the position information display terminal 802.

The posture information acquiring unit 905 acquires posture information of the position information display terminal 802. The image capturing direction in which the position information display terminal 802 is capturing the subject, that is, a direction of the subject as viewed from the position information display terminal 802, can be estimated based on the posture information. The processing unit 906 controls an operation of the position information display terminal 802. The calculating unit 907 calculates the direction of the subject based on the position information, the posture information, and the field angle information of the position information display terminal 802 and the position information of the subject received from the position information providing terminal 803. The recording unit 908 includes a recording medium for recording the position information and the posture information of the position information display terminal 802, the subject identification information, and the position information of the subject received from the position information providing terminal 803. The communication unit 909 and the antenna 910 perform wireless communication with the position information providing terminal 803.

FIG. 10 is a block diagram illustrating a configuration of the position information providing terminal 803 in accordance with the second preferred embodiment of the present invention. A configuration of the position information providing terminal 803 will be described below with reference to FIG. 10. The position information providing terminal 803 according to the second preferred embodiment includes an image pickup unit 1001, a subject identifying unit 1002, a position information acquiring unit 1003, a posture information acquiring unit 1004, a processing unit 1005, a calculating unit 1006, a recording unit 1007, a communication unit 1008, and an antenna 1009. The image pickup unit 1001 corresponds to an image pickup unit in the present invention. The position information acquiring unit 1003 corresponds to an acquiring unit in the present invention. The posture information acquiring unit 1004 corresponds to an estimating unit in the present invention. The calculating unit 1006 corresponds to a calculating unit in the present invention. The communication unit 1008 and the antenna 1009 correspond to a transmitting unit and a receiving unit in the present invention, respectively.

The image pickup unit 1001 generates a real-time image by capturing the subject and measures the distance between the position information providing terminal 803 and the subject. The subject identifying unit 1002 identifies the subject that is being viewed in the real-time image based on subject identification information received from the position information display terminal 802. The position information acquiring unit 1003 acquires position information of the position information providing terminal 803.

The posture information acquiring unit 1004 acquires posture information of the position information providing terminal 803. The processing unit 1005 controls an operation of the position information providing terminal 803. The calculating unit 1006 calculates the position information representing the absolute position of the subject based on the position information and the posture information of the position information providing terminal 803 and the distance to the subject. The recording unit 1007 includes a recording medium for recording the position information of the position information providing terminal 803, the posture information of the position information providing terminal 803, the distance between the position information providing terminal 803 and the subject, the subject identification information, and the position information of the subject. The communication unit 1008 and the antenna 1009 perform wireless communication with the position information display terminal 802.

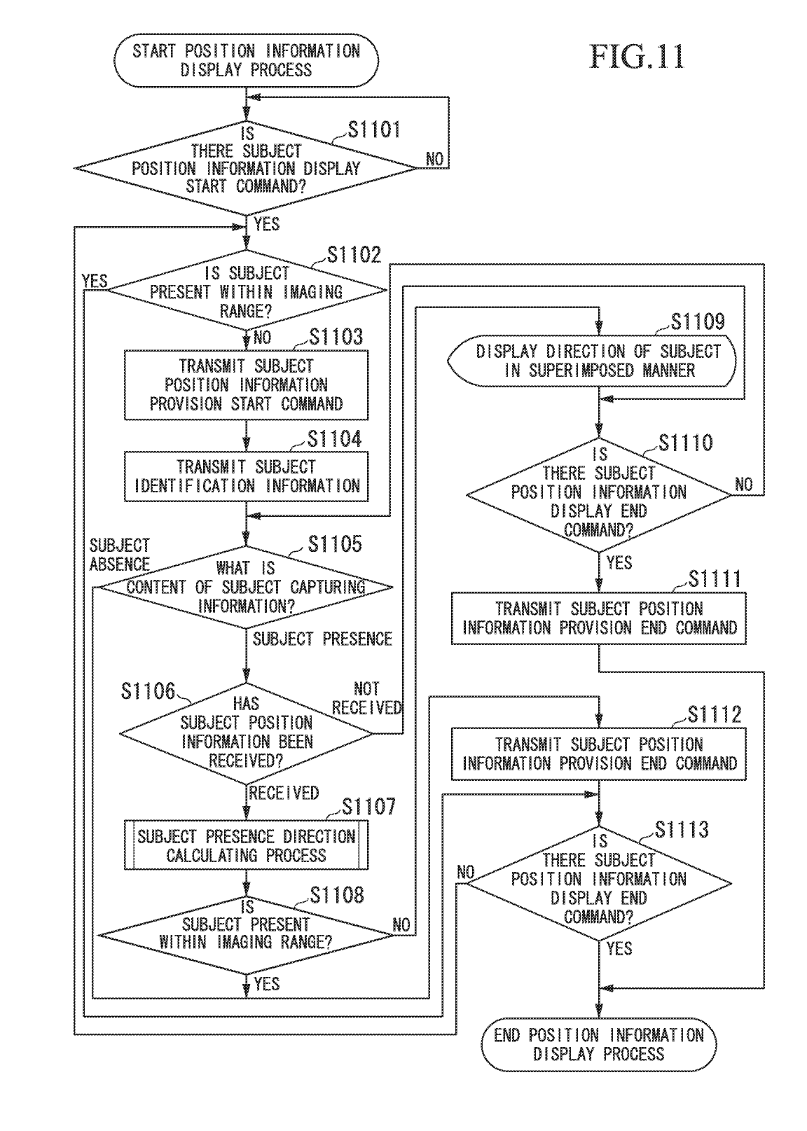

Next, an operation of the position information display terminal 802 in accordance with the second preferred embodiment of the present invention will be described with reference to FIG. 11. FIG. 11 is a flowchart illustrating a procedure of an operation of the position information display terminal in accordance with the second preferred embodiment of the present invention. When a subject position information display start command is received, the position information display terminal 802 starts a position information display process (step S1101). In the second preferred embodiment of the present invention, the subject position information display start command refers to a command that causes the position information display terminal 802 to start the position information display process. In addition, in the second preferred embodiment of the present invention, the subject position information display start command is issued using the fact that the position information providing terminal 803 and the position information display terminal 802 belong to the same network as a trigger. However, the condition under which the subject position information display start command is issued is not limited to this condition. For example, a user interface unit may be further added to the configuration of the position information display terminal 802 illustrated in FIG. 9, and the subject position information display start command may be issued using a user's input as a trigger condition. Various other conditions are also conceivable.

When the subject position information display start command is received, the processing unit 906 issues a subject identification command to the subject identifying unit 902. In the second preferred embodiment of the present invention, the subject identification command refers to a command that causes the subject identifying unit 902 or the subject identifying unit 1002 to determine whether or not the subject specified by the subject identification information is present in the real-time image.

When the subject identification command is received, the subject identifying unit 902 acquires the subject identification information previously stored in the recording unit 908 and determines whether or not the subject specified by the subject identification information is present in the real-time image acquired from the image pickup unit 901 (step S1102). When the subject is present in the real-time image, a subject presence notice is issued to the processing unit 906, and then processing of step S1113 is performed. However, when the subject is not present in the real-time image, a subject absence notice is issued to the processing unit 906, and then processing of step S1103 is performed.

In the second preferred embodiment of the present invention, the subject presence notice is a message notifying the processing unit 906 or the processing unit 1005 of the fact that the subject specified by the subject identification information is present in the real-time image. Further, in the second preferred embodiment of the present invention, the subject absence notice is a message notifying the processing unit 906 or the processing unit 1005 of the fact that the subject specified by the subject identification information is not present in the real-time image.

In the second preferred embodiment of the present invention, the subject identification information refers to information capable of identifying the subject in all directions like an image obtained by capturing the subject in all directions. However, any information capable of identifying the subject in all directions can be used as the subject identification information, and the subject identification information is not limited to an image obtained by capturing the subject in all directions. Further, in the second preferred embodiment of the present invention, the subject identification information previously recorded in the recording unit 908 may include information acquired from the image pickup unit 901 or information acquired via the communication unit 909 and the antenna 910 as long as the acquired information can identify the subject in all directions.

When the subject absence notice is received, the processing unit 906 transmits a subject position information provision start command to the position information providing terminal 803 via the communication unit 909 and the antenna 910 (step S1103). In the second preferred embodiment of the present invention, the subject position information provision start command refers to a command that causes the position information providing terminal 803 to start the position information provision process.

After the subject position information provision start command is transmitted, the processing unit 906 transmits the subject identification information acquired in step S1102 to the position information providing terminal 803 via the communication unit 909 and the antenna 910 (step S1104).

After the subject identification information is transmitted, the processing unit 906 enters a reception standby state for receiving subject capturing information transmitted from the position information providing terminal 803 via the antenna 910 and the communication unit 909 (step S1105). When the received subject capturing information represents that the subject is present in the real-time image of the position information providing terminal 803, the processing unit 906 performs processing of step S1106. However, when the received subject capturing information represents that the subject is not present in the real-time image of the position information providing terminal 803, the processing unit 906 performs processing of step S1112. In the second preferred embodiment of the present invention, information including at least information representing whether or not the subject specified by the subject identification information is present in the real-time image of the position information providing terminal 803 is used as the subject capturing information.

After the subject capturing information representing that the subject is present in the real-time image of the position information providing terminal 803 is received in step S1105, the processing unit 906 enters a reception standby state for receiving the position information of the subject transmitted from the position information providing terminal 803 via the antenna 910 and the communication unit 909 (step S1106). When the position information of the subject is received, the processing unit 906 records the position information of the subject in the recording unit 908 and then performs processing of step S1107. However, when a predetermined time elapses in the reception standby state, the processing unit 906 performs processing of step S1110.

When the position information of the subject is received, the processing unit 906 calculates the direction of the subject based on the position information, the posture information, and the field angle information of the position information display unit 802, and the position information of the subject. After the subject presence direction calculating process is performed, the processing unit 906 issues a subject identification command to the subject identifying unit 902 (step S1107). The subject presence direction calculating process refers to a process of sequentially performing processing of step S604 to step S 607 in FIG. 6 of the first preferred embodiment of the present invention. In steps S604 to S607, the image pickup unit 301, the position information acquiring unit 303, the posture information acquiring unit 304, the processing unit 305, the calculating unit 306, and the recording unit 307 correspond to the image pickup unit 901, the position information acquiring unit 904, the posture information acquiring unit 905, the processing unit 906, the calculating unit 907, and the recording unit 908 in the second preferred embodiment of the present invention, respectively.

When the subject identification command is received, the subject identifying unit 902 performs a determination process that is the same as in step S1102 (step S1108). When the subject is present in the real-time image, the subject presence notice is issued to the processing unit 906, and then processing of step S1112 is performed. However, when the subject is not present in the real-time image, the subject absence notice is issued to the processing unit 906, and then processing of step S1109 is performed.

When the subject absence notice is received in step S1108, the processing unit 906 controls the display unit 903 such that the subject position display information recorded in the recording unit 908 is displayed on the real-time image in the superimposed manner (step S1109).

After the subject position display information is displayed on the real-time image in the superimposed manner, the processing unit 906 determines whether or not the subject position information display end command has been issued (step S1110). When the subject position information display end command has been issued, the processing unit 906 transmits the subject position information provision end command to the position information providing terminal 803 via the communication unit 909 and the antenna 910 (step S111) and ends the position information display process. However, when the subject position information display end command has not been issued, the processing unit 906 performs processing of step S1105.

In the second preferred embodiment of the present invention, the subject position information display end command refers to a command that causes the position information display terminal 802 to end the position information display process. In addition, in the second preferred embodiment of the present invention, the subject position information display end command is issued before departing from a current network using the network departure as a trigger. However, the condition under which the subject position information display end command is issued is not limited to this condition. For example, a user interface unit may be further added to the configuration of the position information display terminal 802 illustrated in FIG. 9, and the subject position information display end command may be issued using the user's input as a trigger condition. Alternatively, when the subject capturing information has not been received a predetermined number of times in step S1105, this fact may be used as a trigger for issuing the command. Various other conditions are also conceivable. Further, in the second preferred embodiment of the present invention, the subject position information provision end command refers to a command that causes the position information providing terminal 803 to end the position information providing process.

When the subject capturing information representing that the subject is not present in the real-time image of the position information providing terminal 803 is received in step S1105 or when the subject presence notice issued in step S1108 is received, the processing unit 906 transmits the subject position information provision end command to the position information providing terminal 803 via the communication unit 909 and the antenna 910 (step S1112).

After the subject position information provision end command is transmitted in step S1112 or when the subject presence notice issued in step S1102 is received, the processing unit 906 determines whether or not the subject position information display end command has been issued (step S1113). When the subject position information display end command has not been issued, the processing unit 906 performs processing of step S1102. However, when the subject position information display end command has been issued, the processing unit 906 ends the position information display process.

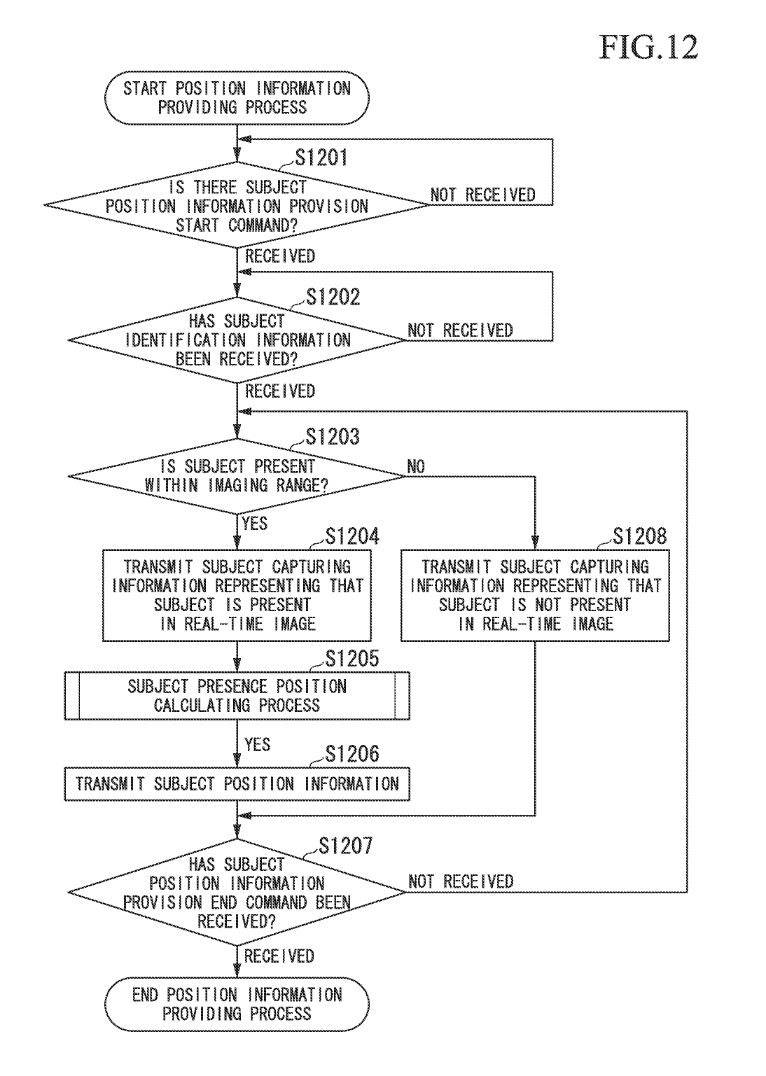

Next, an operation of the position information providing terminal 803 in accordance with the second preferred embodiment of the present invention will be described with reference to FIG. 12. FIG. 12 is a flowchart illustrating a procedure of an operation of the position information providing terminal in accordance with the second preferred embodiment of the present invention. The position information providing terminal 803 starts the position information providing process when the subject position information provision start command is received from the position information display terminal 802 via the communication unit 1008 and the antenna 1009 (step S1201).

When the subject position information provision start command is received, the processing unit 1005 enters a reception standby state for receiving the subject identification information transmitted from the position information display terminal 802 via the communication unit 1008 and the antenna 1009 (step S1202).

When the subject identification information is received, the processing unit 1005 records the subject identification information in the recording unit 1007 and then issues the subject identification command to the subject identifying unit 1002. When the subject identification command is received, the subject identifying unit 1002 acquires the subject identification information, which remains recorded in the recording unit 1007, transmitted from the position information display terminal 802. Then, the subject identifying unit 1002 determines whether or not the subject specified by the subject identification information is present in the real-time image acquired from the image pickup unit 1001 (step S1203). When the subject is present in the real-time image, the subject identifying unit 1002 issues the subject presence notice to the processing unit 1005. However, when the subject is not present in the real-time image, the subject identifying unit 1002 issues the subject absence notice to the processing unit 1005.

When the subject presence notice is received, the processing unit 1005 transmits the subject capturing information representing that the subject specified by the subject identification information is present in the real-time image of the position information providing terminal 803 to the position information display terminal 802 via the communication unit 1008 and the antenna 1009 (step S1204). Meanwhile, when the subject absence notice is received, the processing unit 1005 transmits the subject capturing information representing that the subject is not present in the real-time image of the position information providing terminal 803 to the position information display terminal 802 via the communication unit 1008 and the antenna 1009 (step S1208).

After the subject capturing information representing that the subject specified by the subject identification information is present in the real-time image of the position information providing terminal 803 is transmitted to the position information display terminal 802, the processing unit 1005 calculates the position information of the subject based on the position information and the posture information of the position information providing terminal 803, and the distance between the position information providing terminal 803 and the subject, and then starts a subject presence position calculating process (step S1205). The subject presence position calculating process refers to a process of sequentially performing processing of steps S402 to S405 in FIG. 4 of the first preferred embodiment. In steps S402 to S405, the image pickup unit 201, the position information acquiring unit 202, the posture information acquiring unit 203, the processing unit 204, the calculating unit 205, and the recording unit 206 correspond to the image pickup unit 1001, the position information acquiring unit 1003, the posture information acquiring unit 1004, the processing unit 1005, the calculating unit 1006, and the recording unit 1007 in the second preferred embodiment, respectively.

When the subject presence position calculating process is completed, the processing unit 1005 transmits the position information of the subject recorded in the recording unit 1007 to the position information display terminal 802 via the communication unit 1008 and the antenna 1009 (step S1206). After the position information of the subject is transmitted or after the subject capturing information is transmitted in step S1208, the processing unit 1005 determines whether or not the subject position information provision end command has been received (step S1207). When the subject position information provision end command has not been received, the processing unit 1005 performs processing of step S1203. However, when the subject position information provision end command has been received, the processing unit 1005 ends the position information providing process.

The second preferred embodiment of the present invention has been described above. According to the second preferred embodiment of the present invention, in addition to the effects of the first preferred embodiment of the present invention, it is possible to designate the subject, and transmit and receive the position information only when the designated subject has left a frame.

Further, according to the second preferred embodiment of the present invention, the position information providing terminal 803 calculates the distance to the subject specified by the subject identification information received from the position information display terminal 802, and thus the subject position information related to a desired subject can be calculated.

Furthermore, according to the second preferred embodiment of the present invention, the position information display terminal 802 determines whether or not the subject desired by the operator is present in the real-time image of the position information display terminal 802, and transmits the subject identification information specifying the subject desired by the operator to the position information providing terminal 803. Thus, the position information display terminal 802 can notify the position information providing terminal 803 of the subject desired by the operator.

### Modifications

The preferred embodiments of the present invention have been described above, however, the present invention is not limited to the above two preferred embodiments.

### First Modification

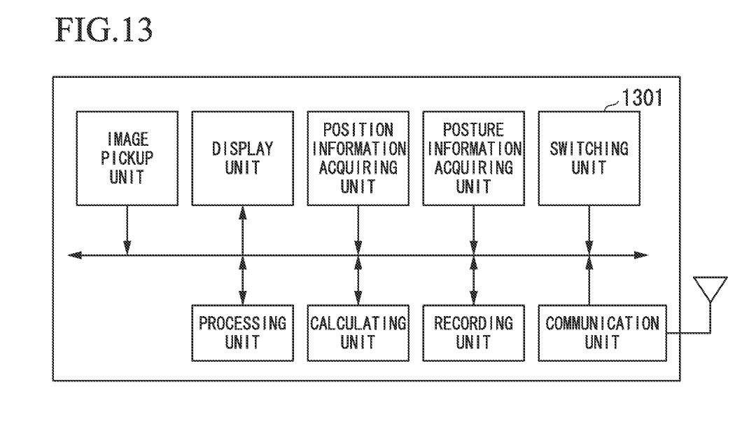

FIG. 13 is a block diagram illustrating a configuration of a modification of the position information providing terminal and the position information display terminal in accordance with the first preferred embodiment of the present invention. For example, in the first preferred embodiment of the present invention, both of the position information providing terminal 102 and the position information display terminal 103 may be configured to perform all of a calculation of the position information of the subject, transmission and reception of the position information of the subject, and display of the position or the direction of the subject. Further, when the position information display terminal and the position information providing terminal have a configuration of the first modification, a configuration (FIG. 13) further providing a switching unit 1301 that selects which of the position information providing process and the position information display process is to be performed may be provided. When the process to be performed is selected, for example, the user's input may be used as a selecting condition, or whether or not the subject is present in the real-time image may be used as the selecting condition. Alternatively, a command from an external terminal may be used as the selecting condition.

### Second Modification

For example, in the first preferred embodiment of the present invention, a system including a plurality of position information providing terminals 102 and a plurality of position information display terminals 103 may be provided. Further, when the system is configured as in a second modification, the process of step S406 of transmitting the position information of the subject may be performed in a multicasting manner. In this case, a configuration (FIG. 13) may be provided in which all pieces of position information of the subject received from the plurality of position information providing terminals 102 are stored and a switching unit 1301 that selects information to be used from the recorded information is provided. Further, when the system is configured as in the second modification, a configuration (FIG. 13) in which the position information display terminal 103 includes not only the functions illustrated in the first modification but also the switching unit 1301 that selects the position information providing terminal 102 from which the position information of the subject used for displaying the position or the direction of the subject is to be received may be provided.

### Third Modification

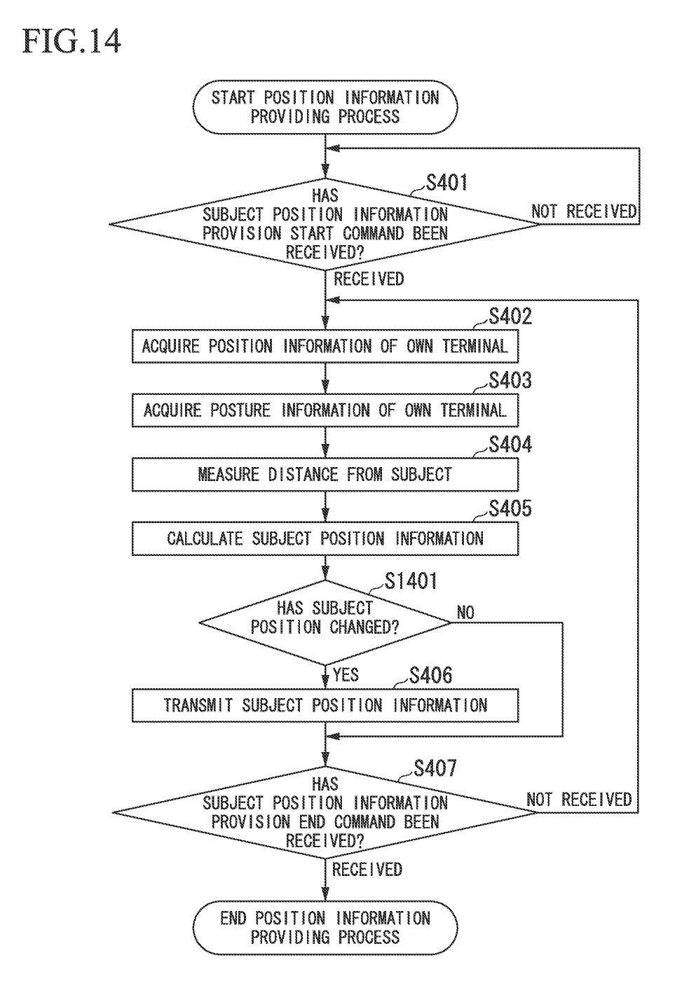

FIG. 14 is a flowchart illustrating a procedure of an operation of a modification of the position information providing terminal in accordance with the first preferred embodiment of the present invention. For example, a process illustrated in FIG. 14 in which step S1401 of transmitting the position information of the subject only when the position information of the subject has changed is added may be used instead of the position information providing process illustrated in FIG. 4 in accordance with the first preferred embodiment of the present invention. In the position information providing process illustrated in FIG. 14, the processing unit 204 determines whether or not the position information of the subject has changed from the position information of the subject that was previously calculated (step S1401). When it is determined in step S1401 that the position information of the subject has changed, the position information of the subject is transmitted in step S406.

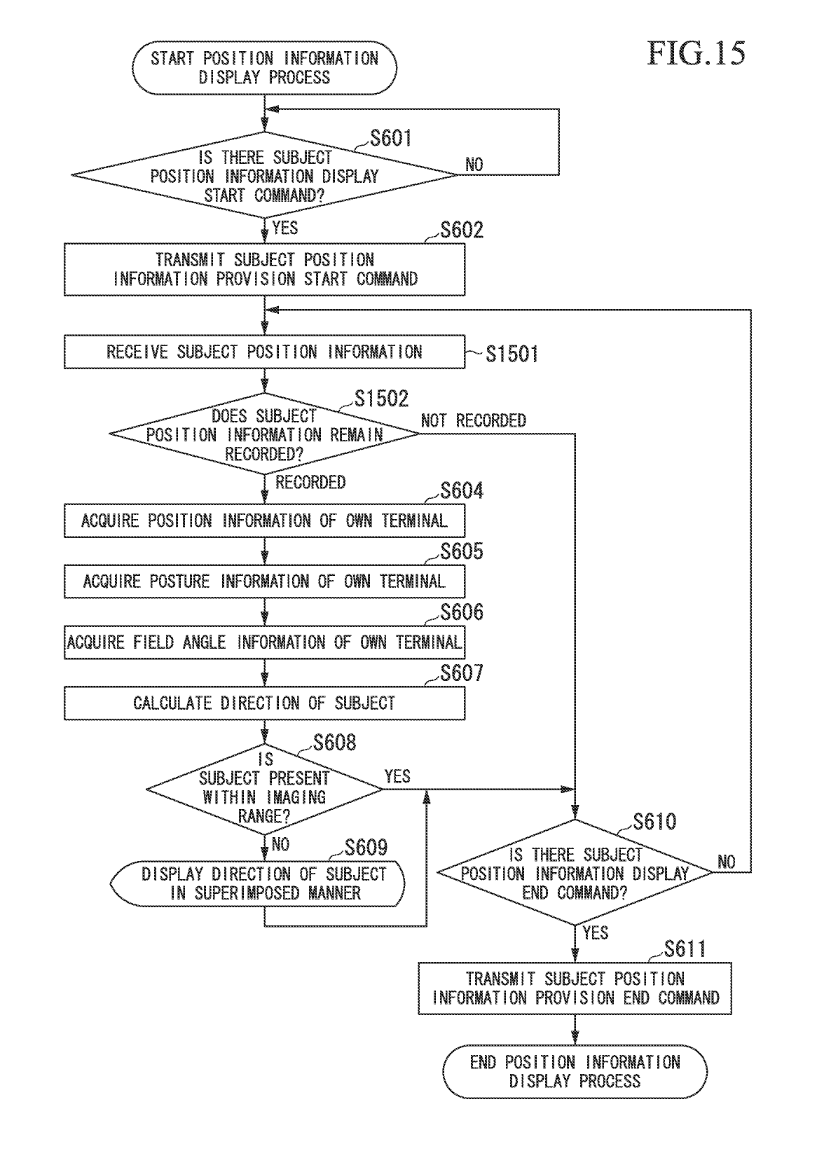

FIG. 15 is a flowchart illustrating a procedure of an operation of a modification of the position information display terminal in accordance with the first preferred embodiment of the present invention. When the position information providing process is identical to the process illustrated in FIG. 14, a process illustrated in FIG. 15 in which steps S1501 and S1502 of displaying the position or the direction of the subject using the position information of the subject recorded in the position information display terminal even when the position information of the subject has not been received are added may be used instead of the position information display process illustrated in FIG. 6. In the position information display process illustrated in FIG. 15, the subject position information is received (step S1501), and when the subject position information is received, the processing unit 305 records the subject position information in the recording unit 307 and then determines whether or not the subject position information remains recorded in the recording unit 307 (step S1502). When it is determined that the subject position information remains recorded in the recording unit 307, processing of step S604 is performed. However, when it is determined that the subject position information remains unrecorded in the recording unit 307, processing of step S610 is performed.

### Fourth Modification

For example, in the second preferred embodiment of the present invention, both of the position information providing terminal 803 and the position information display terminal 802 may be configured to perform all of a calculation of the position information of the subject, transmission and reception of the position information of the subject, and display of the position or the direction of the subject.

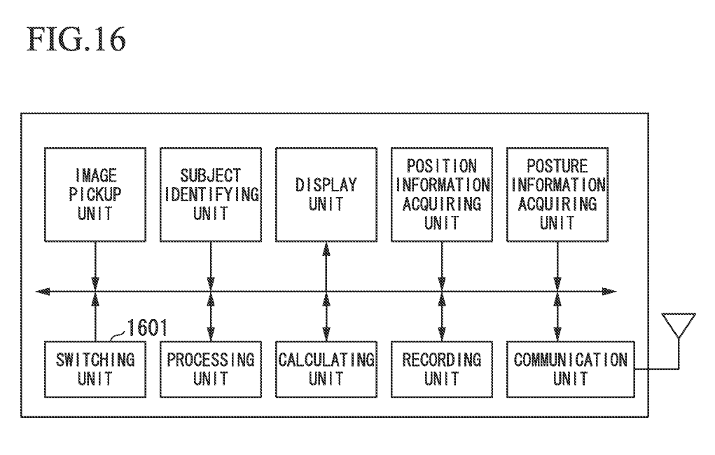

FIG. 16 is a block diagram illustrating a configuration of a modification of the position information providing terminal and the position information display terminal in accordance with the second preferred embodiment of the present invention. When the position information display terminal 802 and the position information providing terminal 803 are configured as in a fourth modification, a configuration (FIG. 16) may be provided in which the position information providing process is performed when the subject is present in the real-time image, the position information display process is performed when the subject is not present in the real-time image, and a switching unit 1601 for controlling switching of an operation is further provided.

### Fifth Modification

For example, in the second preferred embodiment of the present invention, a system including a plurality of position information display terminals 802 and a plurality of position information providing terminals 803 may be provided. Further, when the system is configured as in a fifth modification, the process of step S1206 of transmitting the position information of the subject may be performed in a multicasting manner. In this case, a configuration (FIG. 16) may be provided in which all pieces of position information of the subject received from the plurality of position information providing terminals 803 are stored, and a switching unit 1601 that selects information to use from the recorded information is provided. Further, when the system is configured as in the fifth modification, a configuration (FIG. 16) in which the position information display terminal 802 includes a switching unit 1601 that selects the position information providing terminal 803 from which the position information of the subject used for displaying the position or the direction of the subject is to be received in addition to the functions illustrated in the fourth modification may be provided.

### Sixth Modification

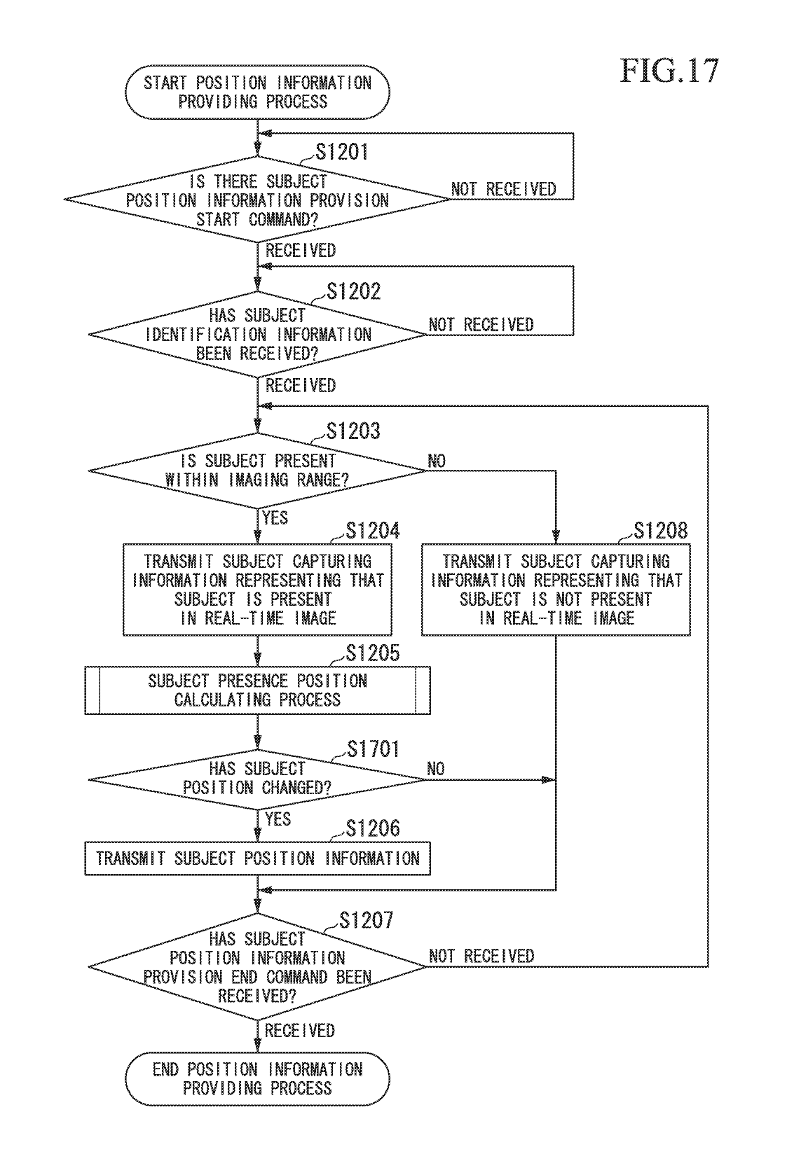

FIG. 17 is a flowchart illustrating a procedure of an operation of a modification of the position information providing terminal in accordance with the second preferred embodiment of the present invention. For example, a process illustrated in FIG. 17 in which step S1701 of transmitting the position information of the subject only when the position information of the subject has changed is added (FIG. 17) may be used instead of the position information providing process illustrated in FIG. 12 in accordance with the second preferred embodiment of the present invention. In FIG. 17, the processing unit 1005 determines whether or not the position information of the subject has changed from the position information of the subject that has been previously calculated (step S1701). When it is determined in step S1701 that the position information of the subject has changed, the position information of the subject is transmitted in step S1206.

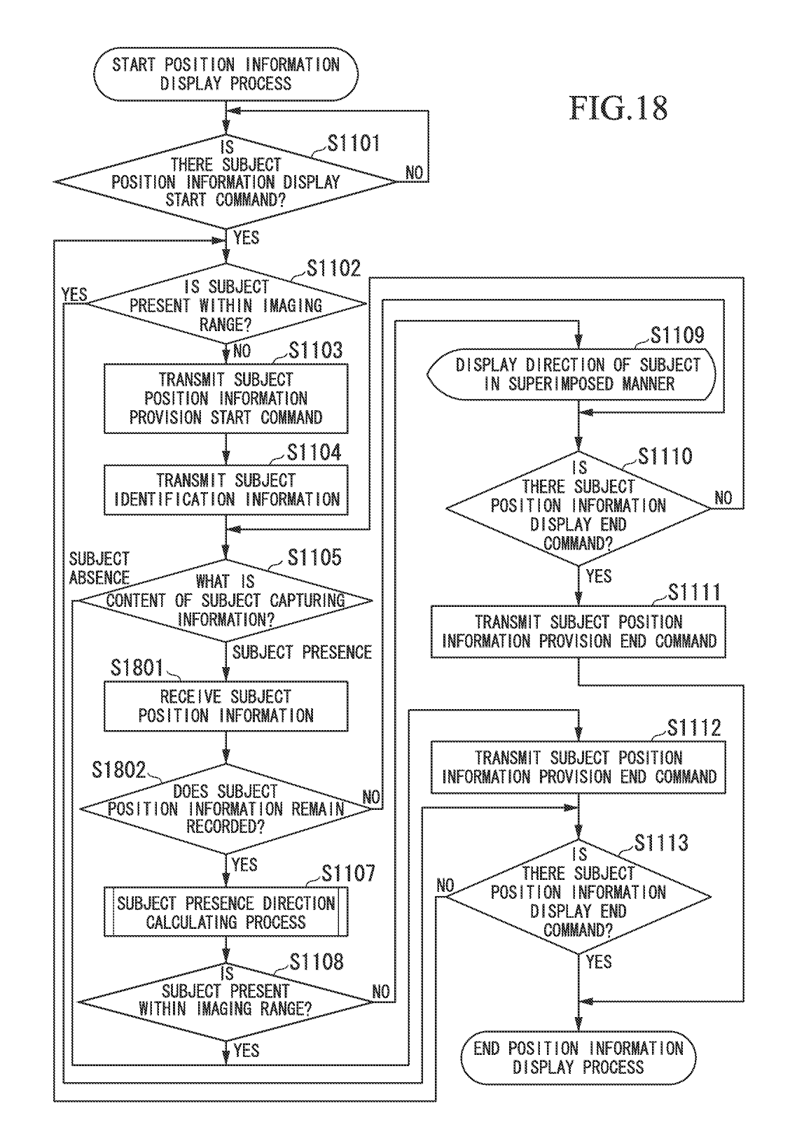

FIG. 18 is a flowchart illustrating a procedure of an operation of a modification of the position information display terminal in accordance with the second preferred embodiment of the present invention. When the position information providing process is identical to the process illustrated in FIG. 17, a process illustrated in FIG. 18 in which steps S1801 and S1802 of displaying the position or the direction of the subject using the position information of the subject recorded in the position information display terminal even when the position information of the subject has not been received are added may be used as the position information display process. In the position information display process illustrated in FIG. 18, the subject position information is received (step S1801), and when the subject position information is received, the processing unit 906 records the subject position information in the recording unit 908 and then determines whether or not the subject position information remains recorded in the recording unit 908 (step S1802). When it is determined that the subject position information remains recorded in the recording unit 908, processing of step S1107 is performed. However, when it is determined that the subject position information remains unrecorded in the recording unit 908, processing of step S1110 is performed.

### Seventh Modification

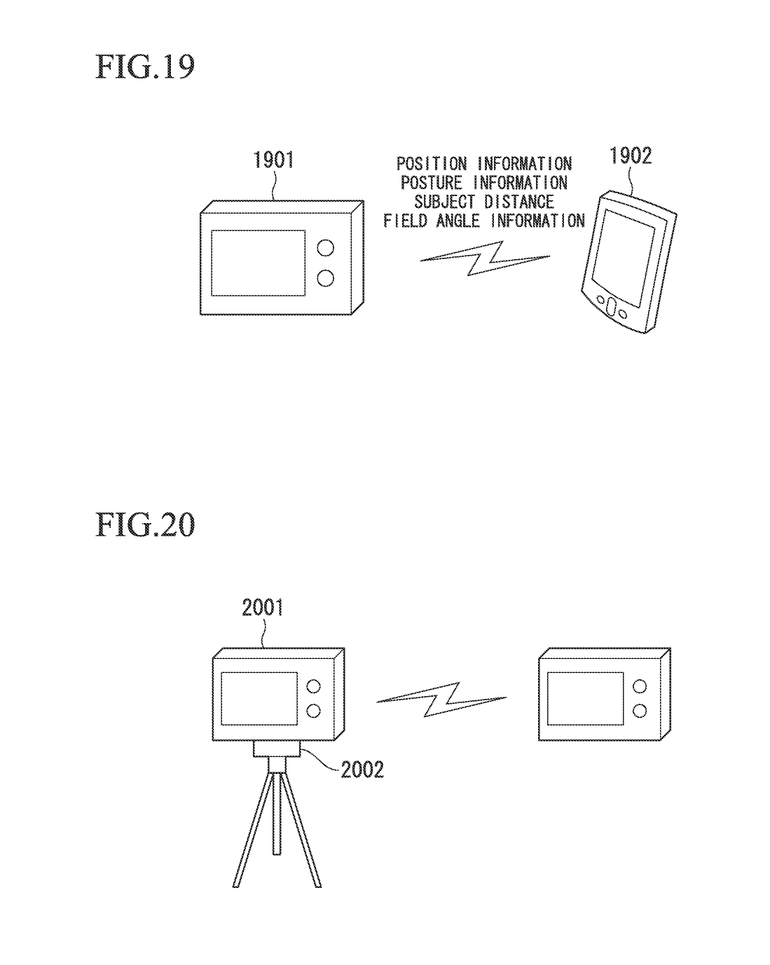

FIG. 19 is a configuration diagram illustrating a configuration of a modification of the subject position notification system in accordance with the first and second preferred embodiments of the present invention. For example, in the first and second preferred embodiments of the present invention, a terminal 1901 that is the position information display terminal or the position information providing terminal may be configured to acquire any or all of the position information, the posture information, the distance between the position information providing terminal and the subject, and the field angle information from an external terminal 1902 via the communication unit and the antenna as illustrated in FIG. 19.

### Eighth Modification

FIG. 20 is a configuration diagram illustrating a configuration of a modification of the subject position notification system in accordance with the first and second preferred embodiments of the present invention. For example, in the first and second preferred embodiments of the present invention, the position information display terminal may be configured as a position information display terminal 2001 that includes an automatic adjusting unit 2002 for automatically adjusting an image capturing direction so that the subject can be positioned in the real-time image (FIG. 20).

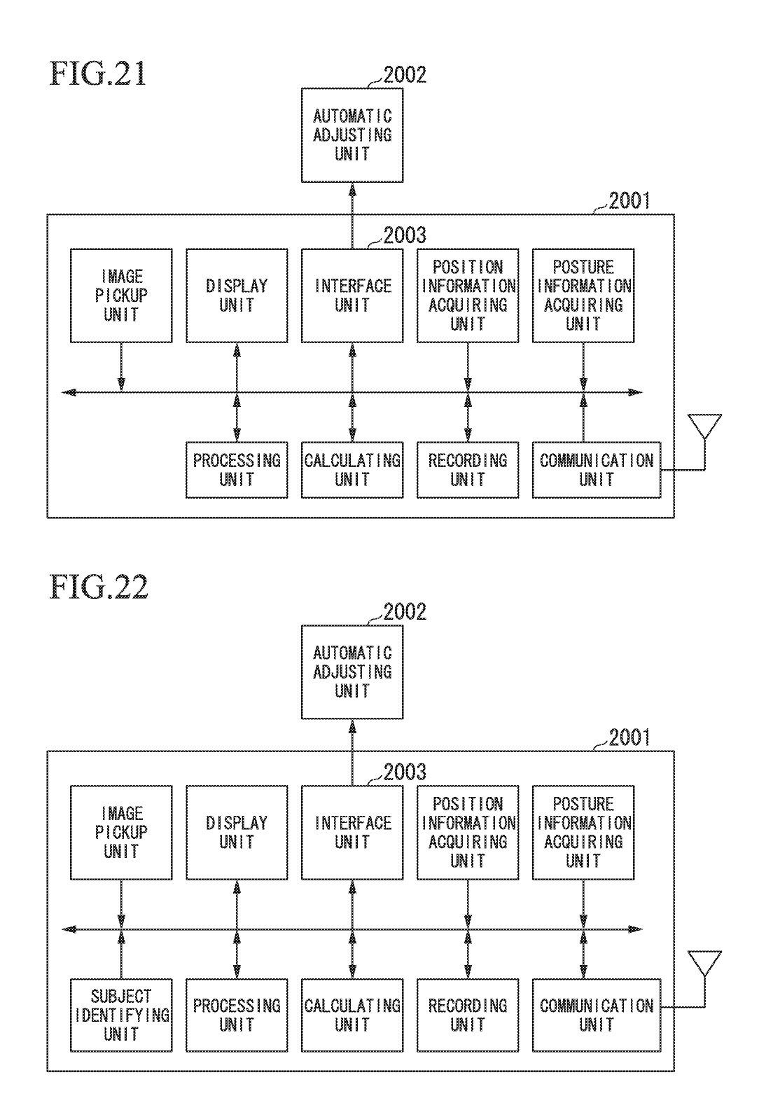

FIG. 21 is a block diagram illustrating a configuration of a modification of the position information display terminal in accordance with the first preferred embodiment of the present invention. In the eighth modification, the position information display terminal 2001 is configured to include the automatic adjusting unit 2002 that adjusts the image capturing direction based on a command from the processing unit which is based on the subject position display information and an interface unit 2003 to which the automatic adjusting unit 2002 is connected in addition to the configuration of the position information display terminal 103 in accordance with the first preferred embodiment of the present invention.

FIG. 22 is a block diagram illustrating a configuration of a modification of the position information display terminal in accordance with the second preferred embodiment of the present invention. In an eighth modification, the position information display terminal 2001 is configured to include the automatic adjusting unit 2002 and the interface unit 2003 in addition to the configuration of the position information display terminal 802 in accordance with the second preferred embodiment of the present invention.

### Ninth Modification

For example, in the first and second preferred embodiments of the present invention, a system in which all pieces of information including the position information and the posture information of the position information providing terminal and the distance between the position information providing terminal and the subject are transmitted from the position information providing terminal to the position information display terminal, and the position information display terminal calculates the position of the subject and notifies of the position or the direction of the subject based on the calculated position information of the subject may be provided.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the invention is not to be considered as being limited by the foregoing description, and is only limited by the scope of the claims.

What is claimed is:

1. An image pickup device comprising:
an image pickup unit that captures a subject;
an acquiring unit that acquires an absolute position of the image pickup device;
an estimating unit that estimates an image capturing direction of the image pickup device;
a receiving unit that receives at least one of first information and second information from an external terminal, the first information representing an absolute position of the subject, the second information representing an absolute position of the external terminal, an image capturing direction of the external terminal, and a distance from the external terminal to the subject; and
a control unit that controls the image capturing direction of the image pickup device or notifies an operator of the image pickup device of information instructing that the image capturing direction be changed, based on the absolute position acquired by the acquiring unit, the image capturing direction estimated by the estimating unit, and at least one of the first information and the second information.

2. The image pickup device according to claim 1, further comprising:
a recognizing unit that recognizes the subject based on an image of the subject captured by the image pickup unit; and
a transmitting unit that transmits information related to the subject recognized by the recognizing unit to the external terminal.

3. The image pickup device according to claim 2, wherein the transmitting unit transmits an image of the subject recognized by the recognizing unit to the external terminal.

4. An image pickup device comprising:
an image pickup unit that captures a subject;
an acquiring unit that acquires an absolute position of the image pickup device;
an estimating unit that estimates an image capturing direction of the image pickup device;
a calculating unit that calculates a distance from the image pickup device to the subject; and
a transmitting unit that transmits at least one of first information and second information to the external terminal, the first information representing an absolute position of the subject calculated based on the absolute position, the image capturing direction, and the distance to an external terminal, the second information representing the absolute position, the image capturing direction, and the distance.

5. The image pickup device according, to claim 4, further comprising a receiving unit that receives an acquisition request of position information of the subject from the external terminal,
wherein the transmitting unit transmits at least one of the first information and the second information to the external terminal after the acquisition request is received.

6. The image pickup device according to claim 4, further comprising a receiving unit that receives information related to the subject from the external terminal,
wherein the calculating unit calculates a distance from the subject related to the information received by the receiving unit.

7. The image pickup device according to claim 4, wherein the transmitting unit repetitively transmits at least one of the first information and the second information.
